(19) United States
(12) Patent Application Publication
(10) Pub. No.: US 2006/0289533 A1
(43) Pub. Date: Dec. 28, 2006

(54) Laundry dryer

(75) Inventors: Hye Yong Park, Changwon-si (KR); Bo Yeon Kim, Changwon-si (KR); Dae Hee Kwon, Busan-si (KR); Hyun Seok Kim, Seoul (KR); Seong Yeol Lee, Daegu-si (KR); Myoung Deok Kim, Changwon-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 11/412,097

(22) Filed: Apr. 27, 2006

(30) Foreign Application Priority Data
Apr. 28, 2005 (KR) 10-2005-35762

(51) Int. Cl. H05B 6/64

(52) U.S. Cl. 219/757

(57) ABSTRACT

A laundry dryer is provided. The laundry dryer includes a cabinet, a drying drum, a heating unit and a blower fan, a cabinet cover, an outer cover, and a fringe frame. The cabinet is opened at a side thereof. The drying drum is disposed within the cabinet, to insert articles to be dried. The heating unit and a blower fan supply hot air into the drying drum. The cabinet cover is installed on the cabinet. The outer cover is detachably coupled to a front of the cabinet cover, painted with a predetermined color on at least a front surface thereof, and injection molded from a heat resistant plastic. The fringe frame encloses a front edge portion of the cabinet.

### BACKGROUND OF THE INVENTION

1. Field of the Invention

The present invention relates to a laundry dryer, and more particularly, to a laundry dryer with an easily interchangeable front portion that enables the front of the dryer to be decorated with a variety of colors according to a user's preferences.

2. Description of the Related Art

In general, a dryer blows hot air inside a drying drum to evaporate moisture in washed, wet laundry inside the drum to dry the laundry. Dryers are largely divided into condensing-type dryers that re-circulate air and do not discharge it from inside the drying drum to the outside, and exhaust-type dryers that exhaust air from the drying drum to the outside after it has absorbed moisture from laundry.

In detail, a dryer has a cylindrical drying drum in which laundry is inserted. When a start button is pressed, a blower fan for blowing air in the drying drum and a heating unit for heating the air fed by the blower fan operate. The hot air that enters the inside of the drying drum absorbs moisture from the laundry and becomes hot and moist. The air that becomes hot and moist vapor leaves the drying drum. In a condenser-type dryer, the air that leaves the drying drum circulates and condenses in a condenser, exchanging heat with indoor air and becoming cooler. The moisture in the circulating air condenses. Conversely, in an exhaust-type dryer, the air that enters the drying drum to become hot and moist is then exhausted out of the dryer.

Drum-type laundry dryers according to the related art include a drum into which laundry is inserted, a cabinet for enclosing and protecting the drum and forming the exterior of the dryer, a motor for driving the drum, and a front portion installed on the front of the cabinet. The front portion has a control panel with various buttons, a door for opening and closing a portal to insert and extract laundry, and a front panel installed to allow the door to pivot and to cover the front portion of the cabinet. The front panel, door, and control panel forming the front portion are coupled firmly with a fastening member.

However, in the case of a laundry dryer according to the related art, the front portion is given a specific permanent color when the product is manufactured. That is, the front portion is painted in the same color as the cabinet. In order to replace the front panel, the entire product must be disassembled or replaced.

Also, in dryers according to the related art, the front panel is formed of a metal material, and is thus expensive to replace and puts a financial burden on the consumer.

Additionally, in a laundry dryer according to the related art, the control panel and the cabinet cover may be scratched, dented, or otherwise damaged during transport or use of the laundry dryer, so that the finish of the front portion is diminished. Also, after a long period of use, a user may grow tired of the color of the front of the laundry dryer.

### SUMMARY OF THE INVENTION

Accordingly, the present invention is directed to a laundry dryer that substantially obviates one or more problems due to limitations and disadvantages of the related art.

An object of the present invention is to provide a laundry dryer that allows a consumer to easily change the color of the front portion of the laundry dryer.

Another object of the present invention is to provide a laundry dryer that can satisfy a variety of consumer tastes by allowing the front portion thereof to be replaced with a variety of colors, patterns, or designs without changing the other parts of the product's exterior in the manufacturing process. The present invention is especially applicable to built-in laundry dryers that only have their front portions exposed to the outside.

A further object of the present invention is to provide a laundry dryer that allows only a section of its outer perimeter that is damaged during transport or assembly to be replaced without having to replace the entire outer portion, in order to facilitate repairs and reduce repair costs.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a laundry dryer including: a cabinet opened at a side thereof; a drying drum disposed within the cabinet, for inserting articles to be dried; a heating unit and a blower fan for supplying hot air into the drying drum; a cabinet cover installed on the cabinet; an outer cover detachably coupled to a front of the cabinet cover, painted with a predetermined color on at least a front surface thereof, and injection molded from a heat resistant plastic; and a fringe frame enclosing a front edge portion of the cabinet.

In another aspect of the present invention, there is provided a laundry dryer including: a cabinet; a drying drum disposed within the cabinet; a heating unit and a blower fan for supplying hot air into the drying drum; a front panel including a cabinet cover installed at a front of the cabinet, and an outer cover made of a material different from the cabinet cover and painted with a colored paint on a front surface thereof, the outer cover coupled at a front of the cabinet cover; a control panel mounted on a top of the front panel; and a fringe panel installed on edges of the front panel and the control panel.

In a further aspect of the present invention, there is provided a laundry dryer including: a cabinet opened on one side thereof; a panel unit coupled to at least one of a top and a bottom of the opened side of the cabinet; a cabinet cover made of a metal material, coupled to at least one of a top portion and a bottom portion of the panel unit, and forming a hole within for inserting and extracting laundry; an outer cover formed of a non-metal material, pressed against a front surface of the cabinet cover, and forming a hole within for inserting and extracting laundry; and a fringe panel forming a front peripheral portion of the cabinet.

The laundry dryer according to the present invention allows a consumer to conveniently change the color of the front portion thereof.

The laundry dryer according to the present invention also allows a variety of consumer tastes to be satisfied by changing only the front portion of the dryer to different colors, patterns, or designs, without having to change the entire exterior.

Additionally, the laundry dryer according to the present invention allows replacement of only the section of the dryer's outer perimeter that is damaged during transport or assembly without having to replace the entire outer portion, in order to facilitate repairs and reduce repair costs.

Moreover, the laundry dryer according to the present invention has a highly-finished edge portion for a high quality look and high value-added.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a laundry dryer according to the present invention;

FIG. 2 is an exploded perspective view of a front portion of a laundry dryer according to the present invention;

FIG. 3 is a frontal perspective view of a cabinet cover of a front portion of a laundry dryer according to the present invention;

FIG. 4 is a rear perspective view of the cabinet cover in FIG. 3;

FIG. 5 is a frontal perspective view of an outer cover of a front portion of a laundry dryer according to the present invention;

FIG. 6 is a rear perspective view of the outer cover in FIG. 5;

FIG. 7 is a frontal perspective view of an upper frame of a fringe frame of a front portion of a laundry dryer according to the present invention;

FIG. 8 is a rear perspective view of the upper frame in FIG. 7;

FIG. 9 is a frontal perspective view of a side frame of a fringe frame of a front portion of a laundry dryer according to the present invention;

FIG. 10 is a rear perspective view of the side frame in FIG. 9;

FIG. 11 is a frontal perspective view of a lower frame of a fringe frame of a front portion of a laundry dryer according to the present invention;

FIG. 12 is a rear perspective view of the lower frame in FIG. 11;

FIG. 13 is a frontal view of a control panel according to the present invention;

FIG. 14 is a rear perspective view of the control panel in FIG. 13;

FIG. 15 is a bottom perspective view of the control panel in FIG. 13;

FIG. 16 is a perspective view of a cabinet on which a front panel is installed according to the present invention;

FIG. 17 is a sectional view showing the assembly of a lower portion of a cabinet cover with a lower panel according to the present invention;

FIG. 18 is a sectional view showing the assembly of an outer cover to a cabinet cover according to the present invention;

FIG. 19 is a schematic sectional view showing an assembled structure of the front portion of a laundry dryer according to the present invention;

FIG. 20 is a sectional view of the laundry dryer in FIG. 1 taken along line I-I′;

FIG. 21 is a sectional view of the laundry dryer in FIG. 1 taken along line II-II′; and

FIG. 22 is a side sectional view showing an upper frame and control panel coupled to an upper panel according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

To explain the laundry dryer according to the present invention, a condensing-type dryer will be used as a representative example.

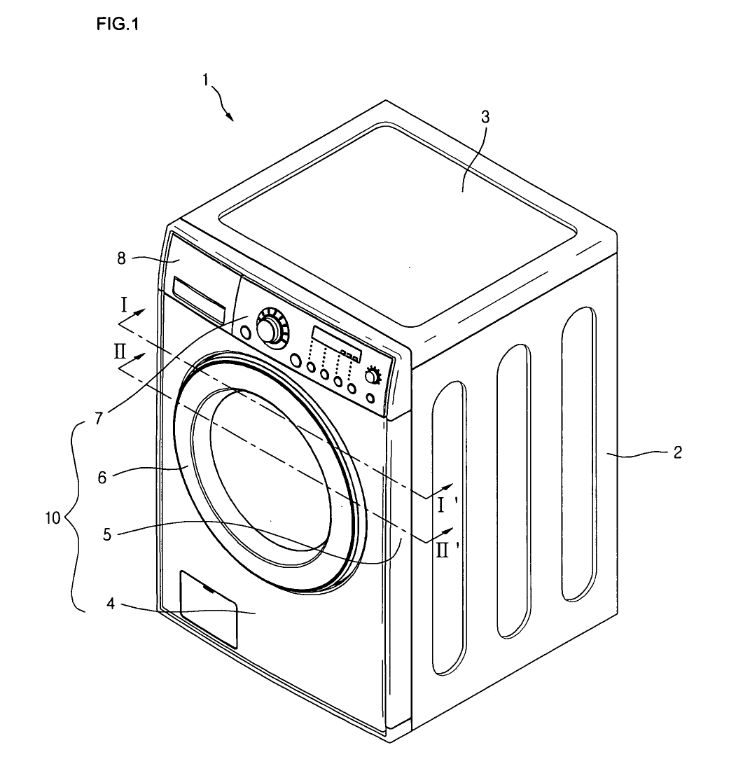

FIG. 1 is a perspective view of a laundry dryer according to the present invention.

Referring to FIG. 1, a condenser-type dryer 1 having a front portion according to the present invention includes a cabinet 2 forming the exterior of the product with an opened front end, a top cover 3 covering the top surface of the cabinet, and a front unit 10 installed on the open front portion of the cabinet 2.

In more detail, the front unit 10 includes a front panel 4, a door 6 pivotably installed at the approximate center of the front panel 4 for inserting and extracting laundry, a control panel 7 mounted above the front panel 4 (and having various buttons for inputting dryer settings, a power button, etc.), and a fringe frame 5 covering the outer perimeter of the front panel 4 and the control panel 7. Also, a drawer 8 is installed on a side of the control panel 7. A drum for receiving laundry is installed inside the cabinet 2. A drive motor for rotating the drum, a heating unit for heating air entering the drum, and a blower fan for blowing heated air into the drum are also installed within the cabinet 2. A base with a built-in condenser is installed at the bottom of the drum.

To describe the operation of the above-structured dryer, a user first opens the door 6, inserts laundry into the drying drum, and closes the door 6. The user then inputs dryer settings and presses the start button. The driving motor, heating unit, and blower fan operate. While the drum rotates, indoor air flows into the drum. The indoor air that flows into the drum is then heated by the heating unit. The heated air flows toward the front from the rear of the drum, drying laundry within the drum. As the laundry dries, the air inside the drum becomes hot and moist, which is exhausted from the drum at its front.

The hot, moist vapor passing from the drum flows through the condenser and cools, losing moisture. As a result, the moisture contained in the moist vapor condenses, and the condensed moisture flows to a condensed water reservoir formed in the approximate center of the base. The water stored in the condensed water reservoir is pumped by a condensed water pump and flows to the drawer 8. When the inputted commands are fulfilled and the drying cycle is completed, the drive motor, blower fan, and heating unit cease operation. When the drawer 8 is filled with condensed water, the user pulls out the drawer 8 when the dryer 1 is not operating and empties the drawer 8.

Below, a more detailed description of the front unit 10 of the laundry dryer 1 will be provided.

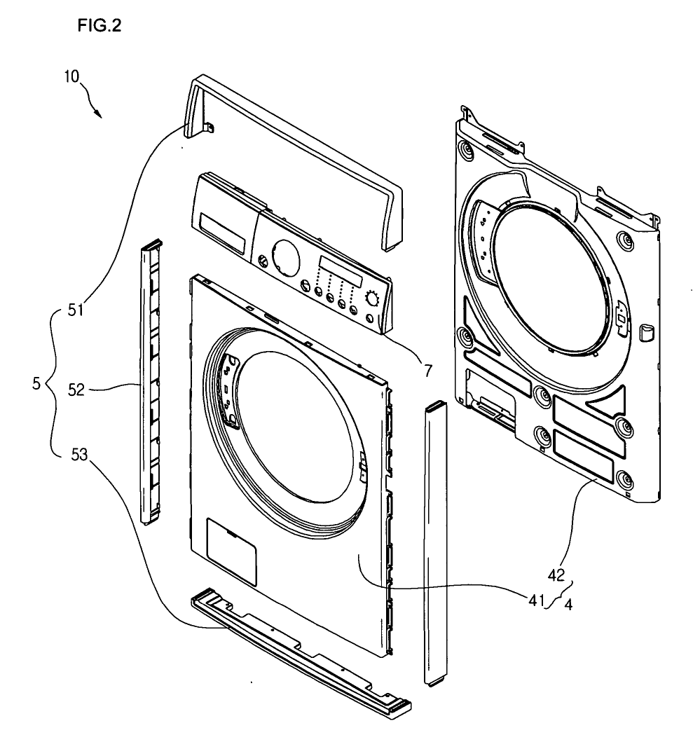

FIG. 2 is an exploded perspective view of a front portion of a laundry dryer according to the present invention. [00531 Referring to FIG. 2, the front unit 10 mounted to the cabinet 2 of the laundry dryer 1 according to the present invention includes a rectangularly shaped front panel 4 covering the open front surface of the cabinet 2, a control panel 7 mounted above the front panel 4, and a fringe frame 5 enclosing the edges of the front panel 4 and the control panel 7.

In further detail, the front panel 4 includes a cabinet cover 42 whose rear perimeter is installed on the front perimeter of the cabinet 2, and an outer cover 41 installed on the front of the cabinet cover 42 and forming the exterior of the laundry dryer 1. The rear perimeter of the cabinet cover 42 is installed on fastening members on the front perimeter of the cabinet 2, so that the cabinet cover 42 functions as a structural reinforcing agent for retaining the shape of the cabinet 2 to prevent denting thereof.

Here, when the cabinet 2 is open at its rear and has the front panel 4 installed at its front, the cabinet cover 42 is integrally connected with either side of the cabinet 2, so that a separate cabinet cover member does not need to be mounted. In other words, only the outer cover 41 may be mounted on the front surface of the cabinet 2.

The outer cover 41, as a plastic injection molded cover applied with a predetermined color, functions as an interior plate for decorating the front exterior of the laundry dryer 1. The outer cover 41 may also easily be removed from the cabinet cover 42 and freely interchanged with a color that a user prefers. Also, the outer cover 41 is formed through plastic injection molding, so that its material cost is less than that of the cabinet cover 42. Thus, replacement of the outer cover 41 is not expensive.

The fringe frame 5 includes a lower frame 53 installed at the lower end of the front panel 4, a side frame 52 installed on either side of the front panel 5, and an upper frame 51 installed on the upper edge portion of the control panel 7.

Specifically, the fringe frame 5 may be made in 4 separate components to surround the front panel 4 and the control panel 7, as described above, or in two parts, where the side panels 52 are integrally formed with the lower panel 7 to form a ‘u’ shape. In addition, the upper frame 51, side frames 52, and lower frame 53 may be integrally formed to create a rectangular overall shape. In other words, the shape and number of pieces forming the fringe frame 5 are not limited to those in the present embodiment, and may adopt various forms and have different numbers of assembled pieces, which falls within the scope of the present invention.

Here, the fringe frame 5 is installed around the outer edges of the front panel 4 and the control panel 7, so that the contacting region between the cabinet cover 42 and the outer cover 41 (at the outer edges thereof) is concealed. Therefore, the front unit 10 has an edge that is clean and has a high-quality finish, due to the fringe frame 5.

The assembly method and process for the various components which compose the front unit 10 will now be described in detail with reference to the diagrams.

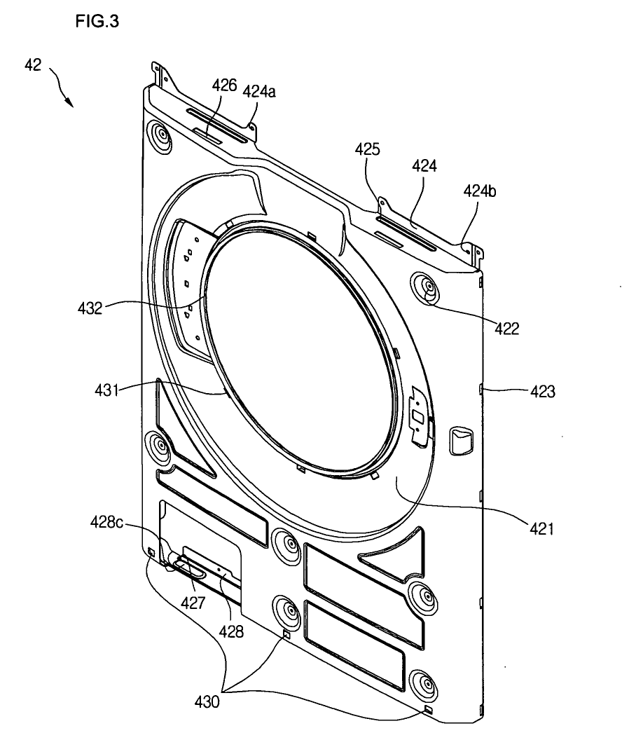

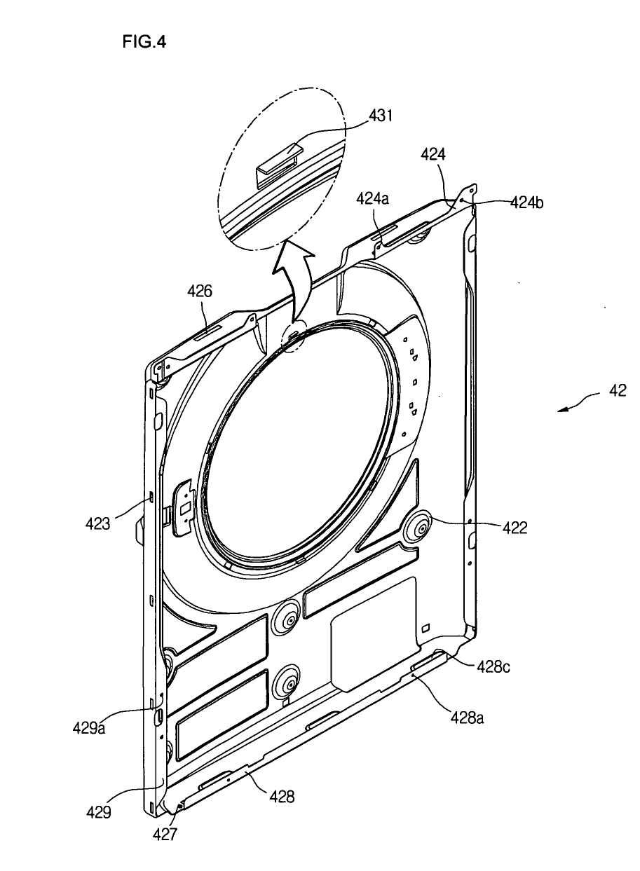

FIG. 3 is a frontal perspective view of a cabinet cover of a front portion of a laundry dryer according to the present invention, and FIG. 4 is a rear perspective view of the cabinet cover in FIG. 3.

Referring to FIGS. 3 and 4, a cabinet cover 42 according to the present invention is installed on the exposed front surface of the cabinet 2, as described above.

In detail, the cabinet cover 42 has its four side edges bent or curved rearward and bent again at an angle of approximately 900 to form a guide rib. The guide rib includes an upper guide rib 424 bent upwards from the top end of the cabinet cover 42, a side guide rib 429 bent inwards from either side edge of the cabinet cover 42, and a lower guide rib 428 formed on the lower surface of the cabinet cover 42 and bent upwards therefrom. A bolting hole 424a is formed in the upper guide rib 424 for inserting a fastening member through. The fastening member that inserts through the bolting hole 424a firmly fastens the cabinet cover 42 to the cabinet 2. Also, bolting holes 429a and 428a are respectively formed in the side guide rib 429 and the lower guide rib 428 to insert fastening members through.

The end portions on either side of the upper guide rib 424 have upper frame fastening holes 424b formed therein. Specifically, a fastening member that inserts through the upper frame fastening hole 424b simultaneously couples the cabinet cover 42 to the upper frame 51 and the cabinet 2. A detailed description is provided below.

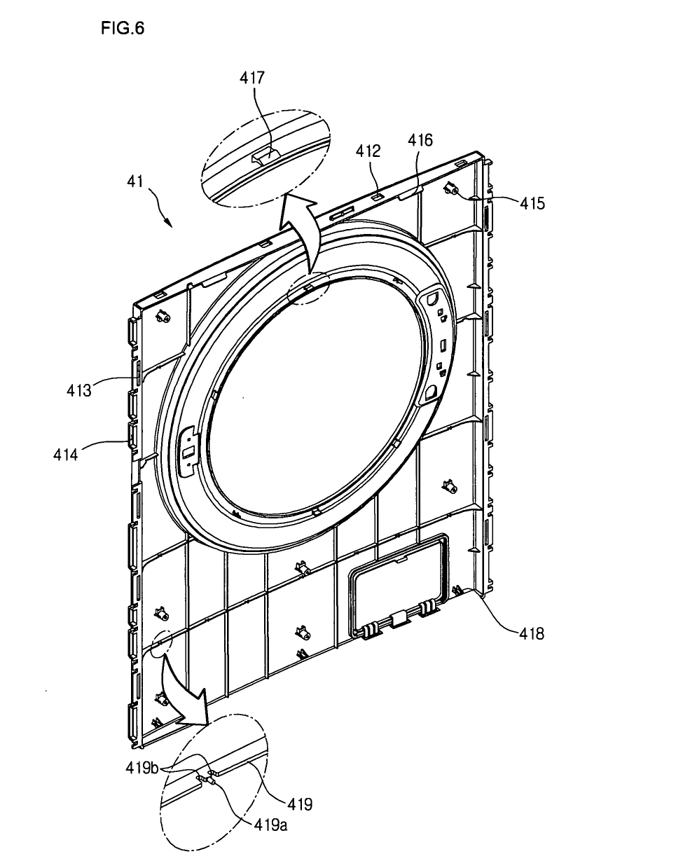

Moreover, the control panel 7 is mounted on the curved surface at the top of the cabinet cover 42, and the side frame 52 is installed on the bent surfaces on either side thereof. The lower frame 52 is coupled to the bent surface at the lower end of the cabinet cover 42. A hook insert hole 423 is formed in the curved surfaces on either side of the cabinet cover 42 for inserting a hook formed on the side frame 52. An upper rib insert hole 426 is formed in the curved surface at the top of the cabinet cover 42 for inserting a coupling rib 416 (in FIG. 6) formed on the upper portion of the outer cover 41. The upper rib insert hole 426 may be formed symmetrically on either side of a line dividing the cabinet cover 42 vertically in two. A drain hole 425 is formed at a position a predetermined distance to the rear of the upper rib insert hole 426. Accordingly, even if water vapor enters the front unit 10 and condenses, it can flow into the cabinet 2 through the drain hole 425, preventing it from entering the door hinge mechanism or the door switch.

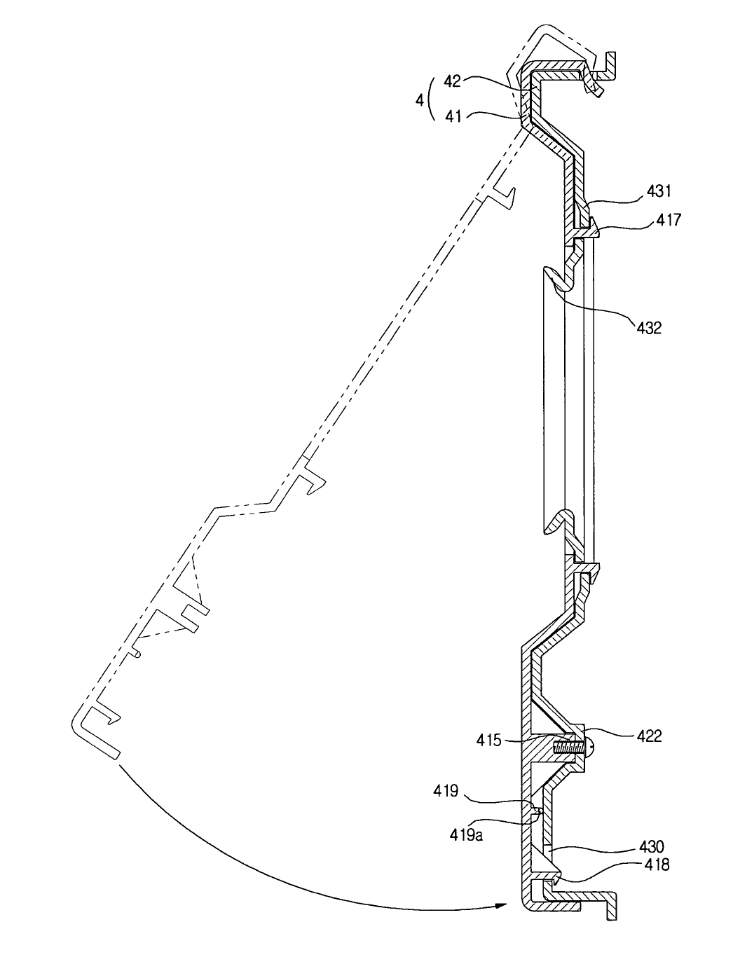

A door mount 421 is formed to recess a predetermined distance and width into the front surface of the cabinet cover 42. The door mount 421 is located where the door is, is shaped in a round shape reflecting that of the door, and forms an open hole through the middle for inserting and extracting laundry through. The edge of the open hole is bent forward, and the end of the bent section is bent again radially to form a gasket mounting rib 432. The shape of the gasket mounting rib 432 can be readily seen in FIG. 18. In detail, the gasket mounting rib 432 is formed as shown, so that a gasket may be inserted in the outer perimeter thereof so that the gasket does not fall out.

A plurality of center hook insert holes 431 are formed at a predetermined interval around the inner circumference of the door mount 421. A plurality of hooks 417 (in FIG. 6) protruding from the rear surface of the outer cover 41 insert in the center hook insert holes 431. By inserting the plurality of hooks formed on the outer cover 41 into the center hook insert holes 431, the cabinet cover 42 and the outer cover 41 may be more tightly coupled. That is, the center hook insert hole 431 is cut and bent using lancing processing on a portion of the inner perimeter of the door mount 421. The cut and bent extending tabs are hooked on the hooks 417 of the outer cover 41.

A plurality of recesses 422 are formed a predetermined depth in the cabinet cover 42 recessed toward the rear. These recesses 422 are for mounting fastening bosses 415 (in FIG. 6) protruding a predetermined distance from the rear surface of the outer cover 41, so that the outer cover 41 and the cabinet cover 42 are prevented from being spaced apart by means of the fastening bosses 415.

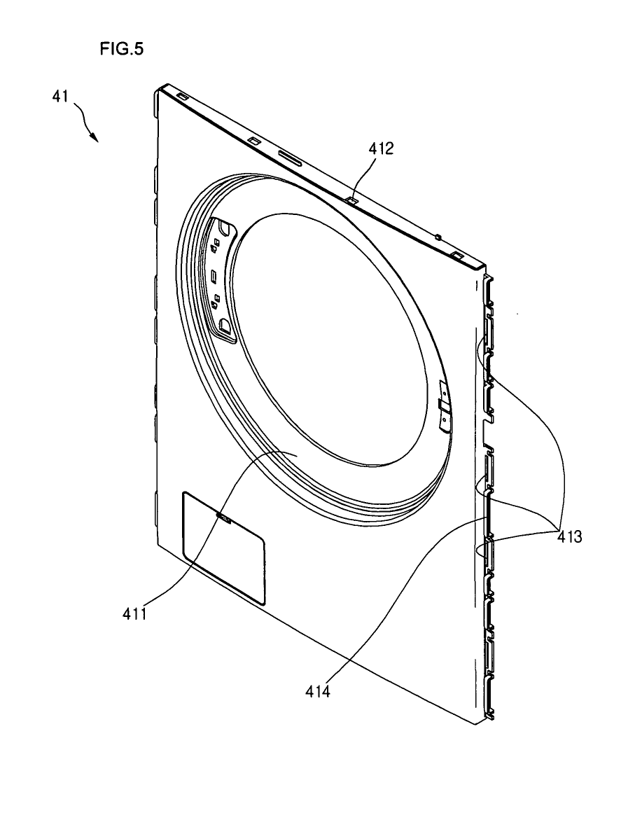

At least one lower rib insert hole 430 is formed at a predetermined interval at the lower end of the front surface of the cabinet cover 42. In more detail, the lower rib insert hole 430 has a lower rib 418 (in FIG. 5) protruding at a predetermined interval from the lower rear surface of the outer cover 41 and inserted therethough. A bolting hole 427 is formed in the lower bent surface of the cabinet cover 42, and is coupled to the lower frame 53 by a fastening member. A supporting slot 428c is formed at a predetermined interval along the bent surface at the bottom of the cabinet cover 42. A supporting rib 221 that protrudes toward the front of the lower panel 22 (to be described later) is inserted in the supporting slot 428c. The process of inserting the supporting rib 221 in the supporting slot 428c will be explained below with reference to the diagrams.

FIG. 5 is a frontal perspective view of an outer cover of a front portion of a laundry dryer according to the present invention, and FIG. 6 is a rear perspective view of the outer cover in FIG. 5.

Referring to FIGS. 5 and 6, an outer cover 4 according to the present invention is mounted to the front surface of the cabinet cover 42, and is formed of a plastic injection molded material having a predetermined color.

Specifically, the outer cover 41 is first formed through plastic injection molding, after which it is sprayed with paint on its front surface and then dried.

In further detail, erosion due to painting of the plastic material should be obviated. Moreover, because the outer cover 41 is manufactured using a relatively large mold, the plastic used to form the outer cover 41 must have favorable flow characteristics during injection molding. Should erosion result from painting, or flow during injection molding be unfavorable, the surface will not be smooth, and an even layer of paint cannot be obtained with painting. When considering such factors, ABS resin such as GP35 manufactured by BASF may be used.

Regarding the mold used for injection molding of the outer cover 41, the portion used to form the front surface of outer cover 41 may have superfinishing treatment so that the front surface of the outer cover 41 can maintain a polish and an even application of paint.

To paint the front surface of the outer cover 41 manufactured through the injection molding process, a paint with an acrylic base resin and a predetermined color is prepared. To create a luster, a metal powder may be added, such as an aluminum powder used in pigments. For mass-production, a spray-on application may be used, for which a solvent may be used in order to reduce the viscosity of the paint. A good solvent to use is isopropylene alcohol.

The outer cover 41 covered with the paint is dried over a predetermined duration at a predetermined temperature.

In further detail, the outer cover 41 may be dried at a temperature of 60°-70° C. for a 40 minute duration. If the paint is dried at a temperature below 60° C., it will not adhere well to the surface and is prone to peeling off when rubbed against other objects. Conversely, if a drying temperature above 70° C. is used, the outer cover 41 will be prone to deformation. Therefore, a material having a heat resistance that prevents deformation thereof at temperatures over 60° C. may be used.

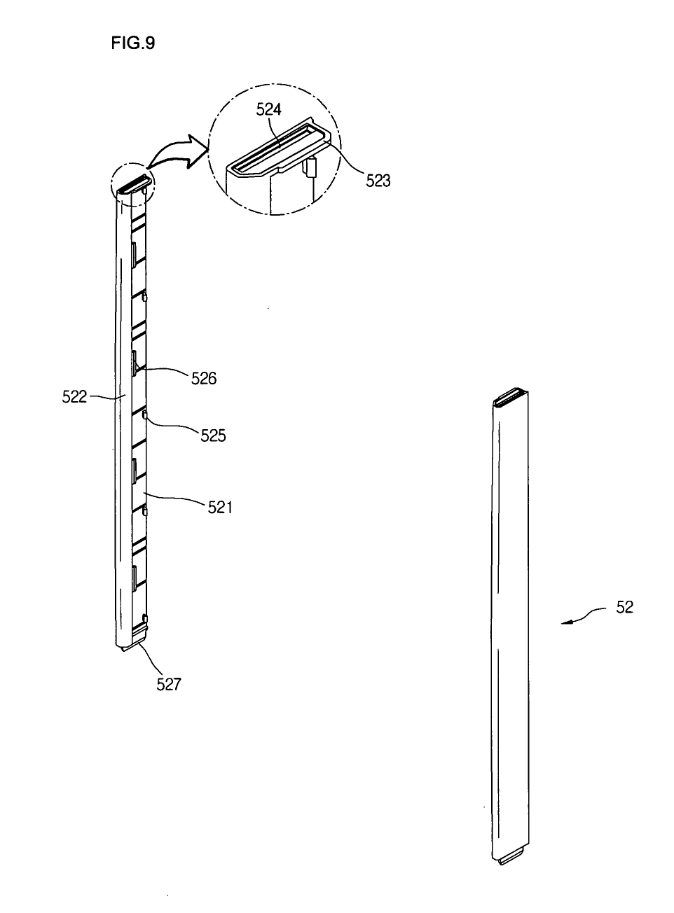

In still further detail, in order to mount the door 6 on the front of the outer cover 41, a door mount 411 is recessed a predetermined depth therein. An open hole is formed within the door mount 411 for inserting and extracting laundry. Around the rear of the perimeter of the open hole, a plurality of center hooks 417 are protrusively formed to insert into center hook insert holes 431 formed on the cabinet cover 42. Side frame fastening tabs 414 for coupling with the side frame 52 are formed to protrude from the side of the outer cover 41. At least one frame rib insert hole 413 is formed between the side frame fastening tabs 414, for inserting a frame rib 526 (in FIG. 9) protruding from the inner surface of the side frame 52. A rib insert hole 412 is formed at a predetermined interval on the upper surface of the outer cover 41, to insert an outer cover fastening rib 75 (in FIG. 15) protruding from the bottom surface of the control panel 7.

At least one upper rib 416 is formed at the rear of the upper portion of the outer cover 41. In detail, the upper rib 416 is inserted into the upper rib insert hole 426 formed on the upper surface of the cabinet cover 42. The process of inserting the upper rib 416 in the upper rib insert hole 426 can be seen in detail in FIG. 18.

A plurality of fastening bosses 415 with a predetermined length are formed at predetermined locations on the rear surface of the outer cover 41. Specifically, the fastening bosses 415 contact the recesses 422 recessed a predetermined depth in the front surface of the cabinet cover 42. A fastening member passes through from the rear surface of the cabinet cover 42 and inserts in a hole formed in the center of the recess 422. Here, the recess 422 is recessed by almost the same distance as the length of the fastening boss 415, so that the outer cover 41 can couple firmly with the front surface of the cabinet cover 42. The fastening member inserts within the fastening boss 415, to firmly couple the cabinet cover 42 and the outer cover 41. As described above, a plurality of lower ribs 418 protrude at the lower end of the outer cover 41 and insert into the lower rib insert holes 430 formed at the bottom of the cabinet cover 42.

Also, ribs 419 formed on the rear surface of the outer cover 41 are latticed.

In detail, to prevent vibration and noise when the outer cover 41 contacts the cabinet cover 42, the contacting surface between the outer cover 41 and the cabinet cover 42 should be minimal, so that a contacting protrusion 419a is formed to protrude from the rib 419 to contact the front surface of the cabinet cover 42. To prevent water from accumulating between the front of the cabinet cover 42 and the rib 419 and resulting corrosion of the cabinet cover 42, the rib 419 has drain grooves 419b formed therein.

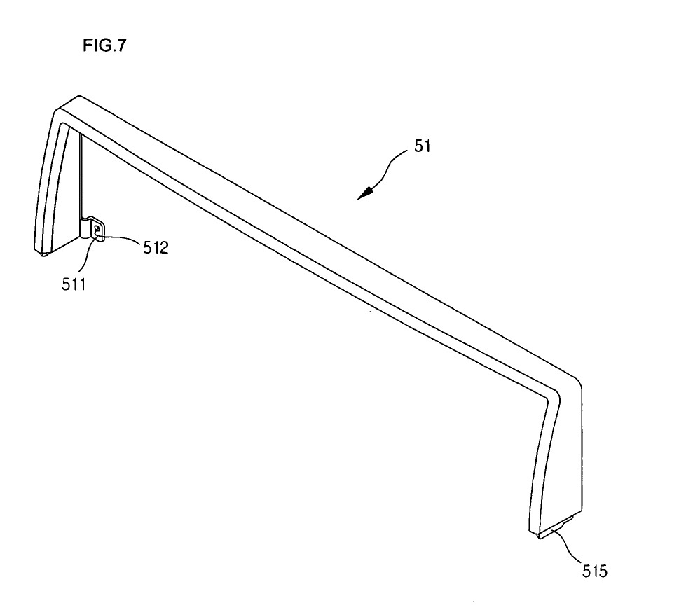

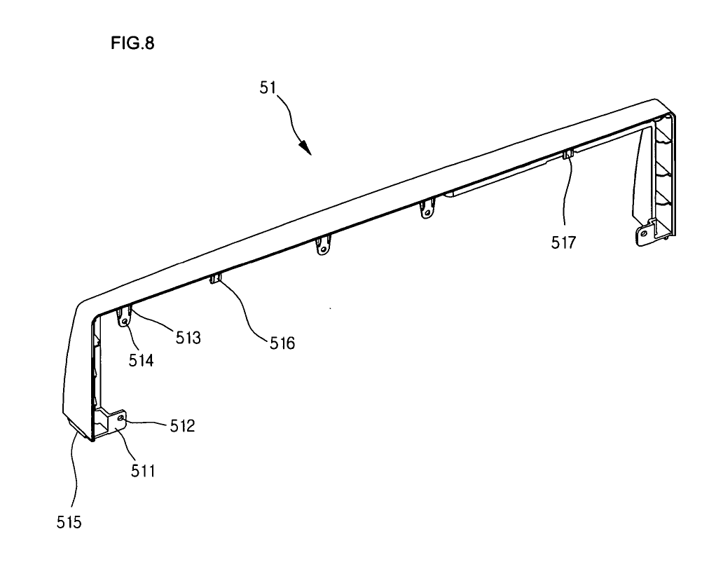

FIG. 7 is a frontal perspective view of an upper frame of a fringe frame of a front portion of a laundry dryer according to the present invention, and FIG. 8 is a rear perspective view of the upper frame in FIG. 7.

Referring to FIGS. 7 and 8, an upper frame 51 that is a component of the fringe frame 5 according to the present invention is formed in an inverted ‘u’ shape in order to cover the upper and side edges of the control panel 7.

Specifically, the upper frame 51 includes a cabinet cover fastening tab 511 extending a predetermined distance from the rear surface on either side thereof, a control panel fastening tab 513 extending a predetermined distance downward from the upper rear portion thereof, and a fixing rib 515 having a predetermined length and width extending from the bottom on either side thereof. Also, a first rib 516 is formed to protrude downward a predetermined distance from the rear upper portion of the upper frame 51, and a second rib 517 is formed at a predetermined distance from the first rib 516 to protrude downward a predetermined distance from the rear upper portion of the upper frame 51. The first and second ribs 516 and 517 insert into insert holes formed in the upper surface of the upper panel (which will be described later), so that the upper frame 51 is fixedly mounted to the upper panel.

In further detail, the cabinet cover fastening tab 511 couples to the upper guide rib 424 that is bent on the upper portion of the cabinet cover 42. In other words, the upper frame fastening hole 424b formed in either side ends of the upper guide rib 424 and the fastening hole 512 formed in the cabinet cover fastening tab 511 are fastened together by means of an inserted screw or other fastening member.

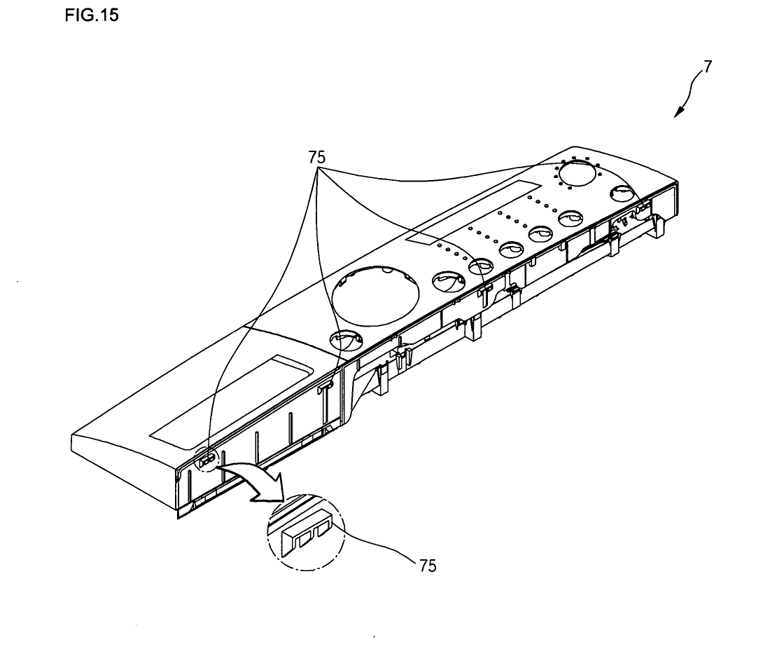

Additionally, the control panel fastening tab 513 is coupled to a fastening boss 73 (in FIG. 14) protruding from the rear surface of the control panel 7. The fixing rib 515 extending from the lower portion on either side of the upper frame 51 inserts in a fixing rib insert hole 524 (in FIG. 9) formed in an upper surface of the side frame 52. That is, in the above assembly process, the upper frame 51 is coupled with the side frame 52 and control panel 7 as well as the cabinet cover 42.

In further detail, the side of the upper frame 51 has side surfaces with a predetermined thickness extending from front to back at the location where the drawer 8 is installed, in order to guide the movement of the drawer 8 when it is inserted or pulled out.

By installing the upper frame 51, the front edge portion of the top cover 3 covering the upper portion of the cabinet 2 is coupled firmly against the rear surface at the top of the upper frame 51.

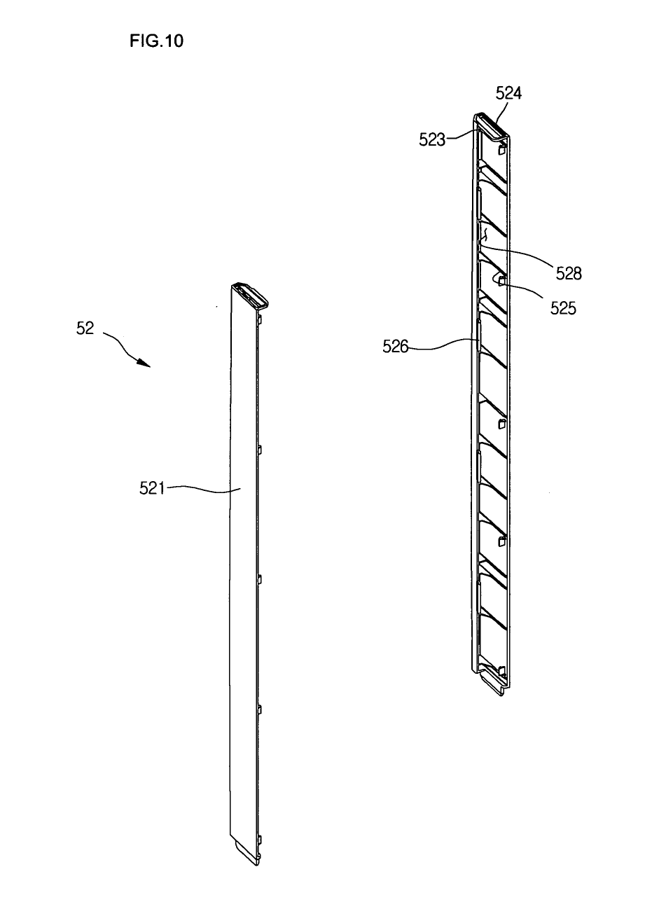

FIG. 9 is a frontal perspective view of a side frame of a fringe frame of a front portion of a laundry dryer according to the present invention, and FIG. 10 is a rear perspective view of the side frame in FIG. 9.

Referring to FIGS. 9 and 10, the side frame 52 according to the present invention is formed in a predetermined width and length to cover the side edges of the cabinet cover 42 and the outer cover 41. By covering the joining portion of the cabinet cover 42 and the outer cover 41, a clean outer appearance is achieved.

In detail, the side frame 52 includes a frame body 521 that is rectangular in shape, a frame front 522 bent at a predetermined curvature from the front end of the frame body 521, an upper frame mounting tab 523 bent horizontally from the upper end of the side frame 52, and a standing rib 527 extending a predetermined length from the lower end of the side frame 52.

In further detail, a fixing rib insert hole 524 is formed on the upper frame mounting tab 523 to insert the fixing rib 515 formed at the bottom end of the upper frame 51. Also, a plurality of frame ribs 526 having a predetermined width and length are spaced a predetermined distance apart on the end of the frame front 522. Here, the frame rib 526 is inserted in the frame rib insert hole 413 formed in the side surface of the outer cover 41.

At least one frame hook 525 protrudes at a predetermined interval from the rear inner side of the frame body 521. That is, the frame hook 525 inserts in the frame hook insert hole 423 formed in the side of the cabinet cover 42.

An insert recess 528 is formed in the inner surface of the frame front 522 in order to insert the side frame fastening tab 414 formed on the side surface of the outer cover 41.

In the above structure, the upper end of the side frame 52 is coupled with the upper frame 51, its lower end is coupled with the lower frame 453, and its inner surface is coupled with the outer cover 41 and the cabinet cover 42. Also, the side frame 52 is coupled to the components without the use of screws or other fastening members.

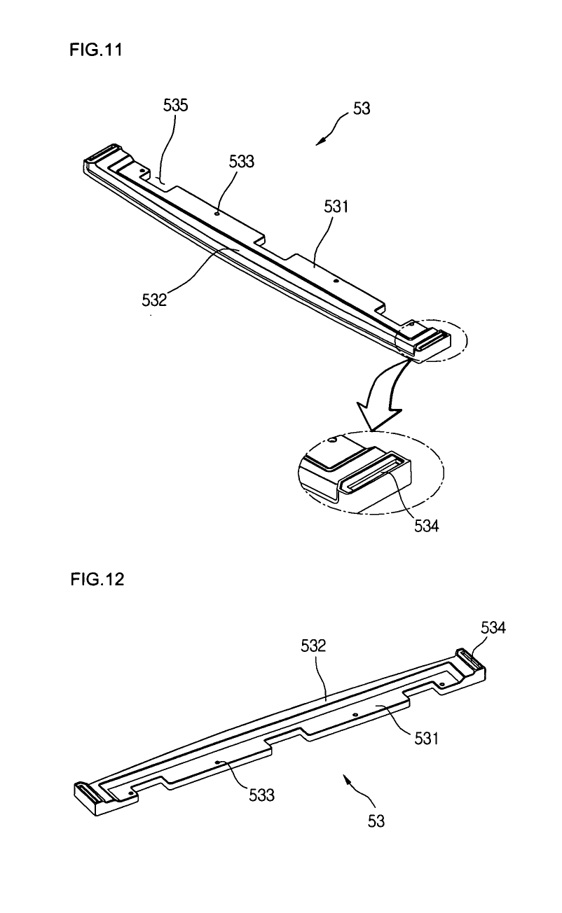

FIG. 11 is a frontal perspective view of a lower frame of a fringe frame of a front portion of a laundry dryer according to the present invention, and FIG. 12 is a rear perspective view of the lower frame in FIG. 11.

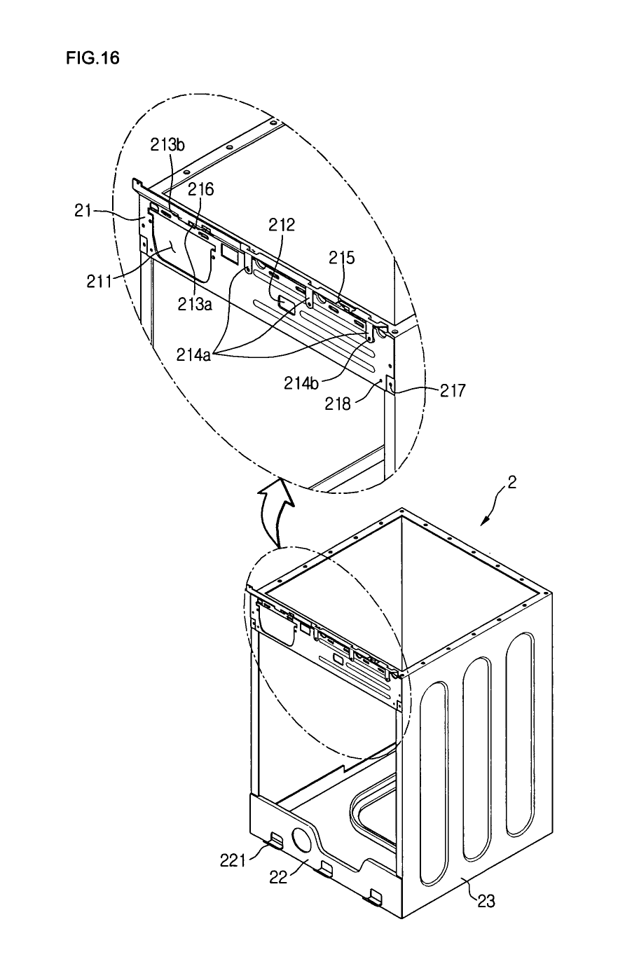

Referring to FIGS. 11 and 12, a lower frame 53 of the fringe frame 5 according to the present invention includes an outer cover mount 532 on its upper surface for mounting the outer cover 41 on, a cabinet cover mount 531 extending a predetermined distance rearward from the outer cover mount 532, and a standing rib insert slot 534 formed in the upper surface on either end, for inserting the standing rib 527 of the side frame 52. A plurality of supporting rib receiving notches 535 are recessed a predetermined depth forward at the rear end of the lower frame 53. Here, the supporting rib receiving notches 535 are formed to prevent a supporting rib 221 (in FIG. 16, to be later described) from interfering with the lower frame 53.

Specifically, at least one bolting hole 533 is formed on the cabinet cover mount 531, so that the lower frame 53 and the cabinet cover 42 can be coupled with a fastening member. In more detail, a screw or other fastening member inserts through the bolting hole 533 and the bolting hole 427 formed in the lower end of the cabinet cover 42. Thus, the lower frame 53 is coupled to the cabinet cover 42 by means of the screw or other fastening member, and both its end portions are assembled with the side frame 52.

The fringe frame 5 that covers the edges of the front panel 4 and the control panel 7 prevents the front panel 4 and the control panel 7 from being damaged due to external forces. Supposing that a shock is applied from the outside, only a portion of the fringe frame 5 is damaged, protecting the front panel 4. Also, only the damaged portion of the fringe frame 5 needs to be replaced, not only facilitating repair, but also reducing repair costs.

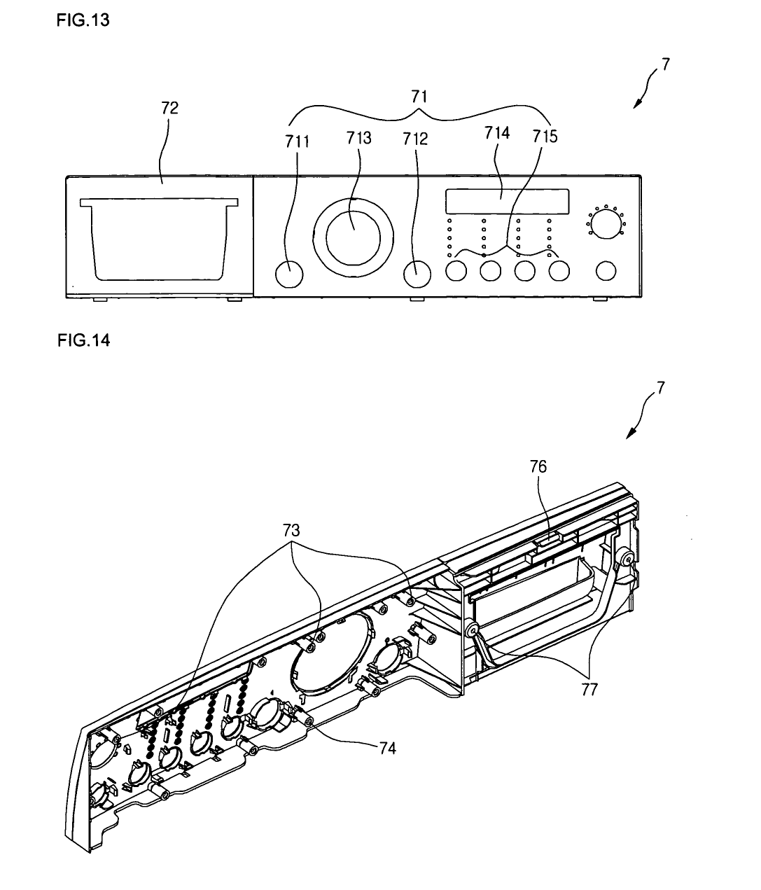

FIG. 13 is a frontal view of a control panel according to the present invention, FIG. 14 is a rear perspective view of the control panel in FIG. 13, and FIG. 15 is a bottom perspective view of the control panel in FIG. 13.

Referring to FIGS. 13 through 15, a control panel 7 according to the present invention is enclosed on its upper and side surfaces by the upper frame 51, and its lower portion is coupled to the upper surface of the front panel 4.

Specifically, the control panel 7 includes an input section 71 on one side of a front thereof with various controls, and a drawer section 72 on the other end of the front section for inserting the drawer into.

In further detail, the input section 71 includes a power button 711, a dial knob insert hole 713 for inserting a dial knob that inputs commands, a start button 712, a display 714, and setting buttons 715 for inputting settings.

Installed at the back of the control panel 7 is a PCB (printed circuit board) for storing and implementing the commands inputted through the input section 71.

In more detail, a PCB fastening boss protrudes a predetermined length from the rear surface of the control panel 7, in order to mount the PCB thereon. An upper frame fastening boss 73 is formed to protrude from the rear upper end of the control panel 7, so that the upper frame fastening boss 73 is pressed against the front surface of an upper frame fastening tab 214a (in FIG. 16) formed on the upper panel 21. Here, the control frame fastening tab 513 formed on the upper frame 51 is pressed against the rear surface of the upper frame fastening tab 214a. Accordingly, after a screw or other fastening member inserts from the rear to the front of the fastening hole 514 formed on the control panel fastening tab 513, it is inserted into the upper frame fastening boss 73, so that the control panel 7 and the upper frame 51 are assembled integrally with the upper panel 21.

FIG. 23 shows the above assembly structure in more detail.

An outer cover fixing rib 75 is formed at a predetermined interval on the front surface of the control panel 7. The outer cover fixing rib 75 inserts into the rib insert hole 412 formed in the upper surface of the outer cover 41. Thus, when the control panel 7 is mounted on the outer cover 41, there is no oscillating thereof due to external forces.

Also, a panel hook 76 is formed on the rear surface at the top of the control panel 7 and is inserted into a hole 213a (in FIG. 16) to be described later, so that the control panel 7 does not move with respect to the upper panel. A dispenser fastening boss 77 is formed to protrude from the rear surface of the control panel 7. A fastening member is inserted from the front of the control panel 7 into the dispenser fastening boss 77. The fastening member passing through the dispenser fastening boss 77 is inserted into a fastening hole (not shown) formed at the front surface of the dispenser installed inside the cabinet 2 for holding the drawer. That is, the control panel 7 is coupled to the dispenser to prevent movement thereof.

FIG. 16 is a perspective view of a cabinet on which a front panel is installed according to the present invention.

Referring to FIG. 16, the cabinet 2 according to the present invention includes a main body 23 recessed in a rough ‘n’ shape when viewed in a horizontal section, an upper panel connecting both ends of the main body 23, and a lower panel 22.

In detail, the cabinet 2 has either an open front where the front panel 4 is installed and has its side and rear surfaces integrally formed, or has its side surfaces integrally formed with the front panel 4 with the rear opened.

The cabinet 2 may have separate components assembled to compose its four surfaces, an opening formed in one of the surfaces for inputting laundry, and the front panel 4 installed on the surface in which the opening is formed.

Also, built-in type laundry dryers may not include the side or rear cabinets.

Here, the shape of the cabinet 2 is not limited to those described in the above embodiments, but may adopt a variety of shapes and still fall within the scope of the present invention.

The upper panel 21 installed on the front surface at the top of the main body 23 includes a drawer insert hole 211 formed at one side thereof for inserting the drawer therein, an electric wire insert hole 212 cut a predetermined size in the approximate center of the upper panel 21 for inserting wires connected to the control panel 7 through, a hook insert hole 213a formed in the upper edge of the upper panel 21 for inserting the panel hook 76 formed on the control panel 7, and a hook latch tab 213b for latching the hook 76 and preventing it from detaching.

The upper panel 21 also includes at least one upper frame fastening tab 214a extending a predetermined distance downward from the upper edge of the upper panel, and a first and a second rib insert hole 215 and 216 formed on the upper edge of the upper panel. Here, the first and second ribs 516 and 517 formed on the rear surface of the upper frame 51 are inserted into the first and second rib insert holes 215 and 216.

In detail, the fastening hole 214b is formed on the end of the upper frame fastening tab 214a, for inserting a fastening member through. The control panel fastening tab 513 of the upper frame 51 is disposed at the rear surface of the upper frame fastening tab 214a. The upper frame fastening boss 73 protruding from the rear surface of the control panel 7 is disposed on the front surface of the upper frame fastening tab 214a. A fastening member passes through the control panel fastening tab 513 and the upper frame fastening tab 214a and inserts in the upper frame fastening boss 73.

The upper panel 21 also includes a cabinet cover fastening hole 217 on the bottom at either end thereof for fastening to the cabinet cover 42, and an upper frame fastening hole 218 for fastening with the upper frame 51. Here, an upper frame fastening hole 424b formed on the cabinet cover 42 is disposed at the front surface of the upper frame fastening hole 218. The cabinet cover fastening tab 511 formed on the upper frame 51 is disposed at the front surface of the upper frame fastening hole 424b. In other words, the fastening hole 512 formed in the cabinet cover fastening tab 511 is disposed in front of the upper frame fastening hole 424b. Accordingly, the upper frame 51, cabinet cover 42, and upper panel 21 are integrally coupled by means of a fastening member.

The panel hook 76 formed on the rear surface of the control panel 7 inserts in the hook insert hole 213a formed in the upper portion of the upper panel 21, and the upper surface of the panel hook 76 hooks onto the hook latch tab 213b. Thus, the control panel 7 couples at one end to the upper panel 21, where the panel hook 76 does not detach easily. Also, the first and second ribs 516 and 517 protruding from the upper rear surface of the upper frame 51 insert respectively into the first and second rib insert holes 215 and 216 formed on the upper edge surface of the upper panel 21, so that the upper frame 51 is coupled to the upper panel 21 and does not move.

The lower panel 22 coupled at the bottom of the main body 23 has at least one supporting rib 221 formed at a predetermined interval at the bottom thereof.

In detail, the supporting rib 221 is cut in a predetermined size from a portion of the lower panel 22, and the cut portion is then bent forward at a predetermined angle through lancing processing, as shown in the FIG. 16. The supporting rib 221 is inserted into the supporting slot 428c formed in the bent surface of the lower portion of the cabinet cover 42, as described above.

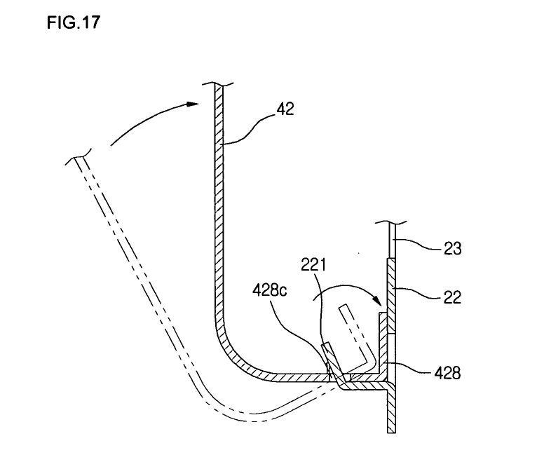

FIG. 17 is a sectional view showing the assembly of a lower portion of a cabinet cover with a lower panel according to the present invention.

Referring to FIG. 17, a lower portion of the cabinet cover 42 according to the present invention is fastened by means of the supporting rib 221 of the lower panel 22.

In detail, the supporting rib 21 is bent in a forward and upward shape, where the upwardly bent portion is bent slightly to incline forward. Thus, in order to insert the supporting rib 21 in the supporting slot 428c, the upper portion of the cabinet cover 42 is first inclined forward at a predetermined angle. In this state, the end of the supporting rib 221 is inserted into the supporting slot 428c, and then the upper portion of the cabinet cover 42 is pushed and rotated to press against the upper panel 21 of the cabinet 2. Thus, the lower surface of the cabinet cover 42 mounts to the upper surface of the supporting rib 221, and the lower guide rib 428 of the cabinet cover 42 presses against the front surface of the lower panel 22.

FIG. 18 is a sectional view showing the assembly of an outer cover to a cabinet cover according to the present invention.

Referring to FIG. 18, an outer cover 41 according to the present invention is first coupled at its upper surface to the upper surface of the cabinet cover 42, after which other portions are coupled.

In detail, a plurality of upper ribs 416, spaced a predetermined distance apart from each other, are formed on the upper edge surface of the outer cover 41 to extend downward. The upper ribs 416 extend vertically and then curve gently or bend abruptly rearward. Thus, in order to fasten the outer cover 41 to the cabinet cover 42, the lower end of the outer cover 41 is lifted slightly. Then, the curved portion of the upper rib 416 is inserted into the upper rib insert hole 426. Next, the outer cover 41 is rotated and pressed against the front of the cabinet cover 42. In this way, the upper rib 416 is completely inserted into the upper rib insert hole 426.

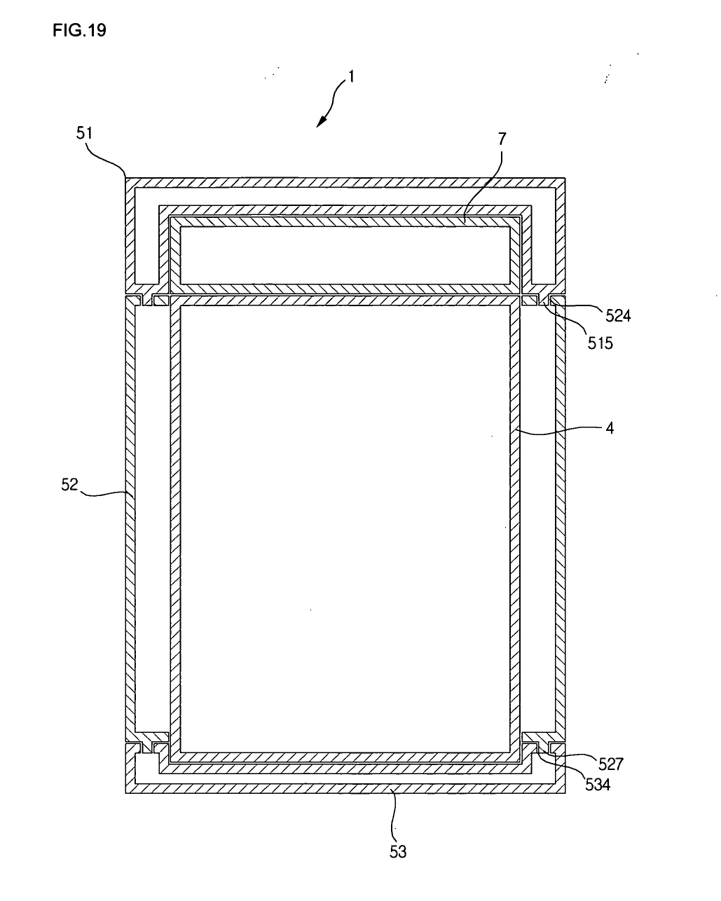

FIG. 19 is a schematic sectional view showing an assembled structure of the front portion of a laundry dryer according to the present invention.

Referring to FIG. 19, the fringe frame 5 surrounds the edges of the front panel 4 and the control panel 7, and the different components of the fringe frame 5 are tightly coupled together.

In detail, the fringe frame 5 protects the sides with the side frames 52 that enclose both sides of the front panel 4. Coupled above the side frame 52 is the upper frame 51, and coupled therebelow is the lower frame 53. The fixing rib 515 protruding from the bottom of the upper frame 51 inserts into the upper surface of the side frame 52, so that the pieces do not move. The standing rib 527 protruding from the bottom of the side frame 52 inserts into the upper surface of the lower frame 53, so that the pieces do not move.

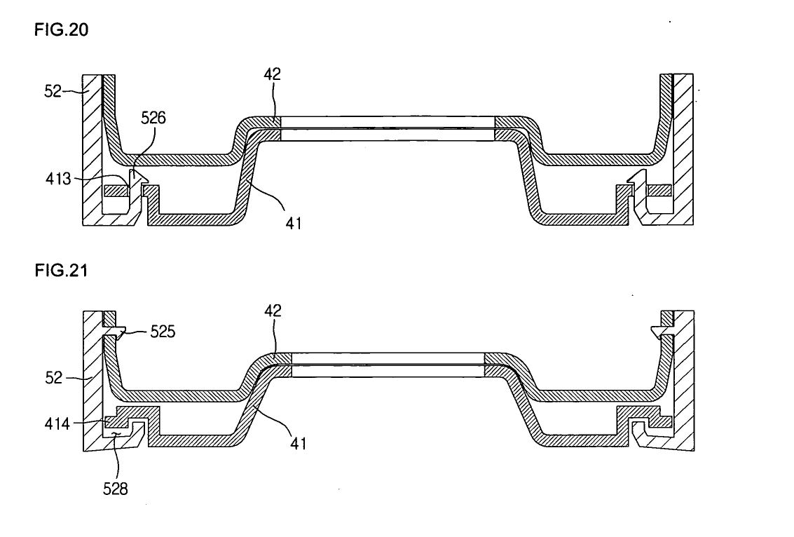

FIG. 20 is a sectional view of the laundry dryer in FIG. 1 taken along line I-I′.

Referring to FIG. 20, the side frame 52 according to the present invention is integrally coupled with the outer cover 41 and the cabinet cover 42, so that the sides of the outer cover 41 and the cabinet cover 42 are concealed.

In further detail, the frame rib 526 of the side frame 52 inserts into the frame rib insert hole 413 formed on the side surface of the outer cover 41, so that the side frame 52 is fixed to the outer cover 41. The cabinet cover 42 is firmly coupled to the rear of the outer cover 41.

FIG. 21 is a sectional view of the laundry dryer in FIG. 1 taken along line II-II′.

Referring to FIG. 21, the side frame fastening tab 414 formed on the side surface of the outer cover 41 inserts into the insert hole 528 formed at the front of the side frame 52. The frame hook 525 protruding from the inner rear surface of the side frame 52 inserts in the frame hook insert hole 423 formed on the side surface of the cabinet cover 42.

In the above assembly configuration, the cabinet cover 42 and the outer cover 41 couple integrally to the side cover 52.

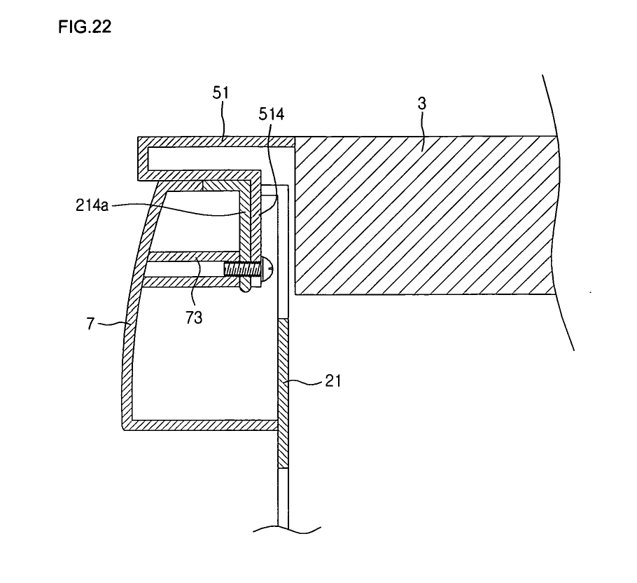

FIG. 22 is a side sectional view showing an upper frame and control panel coupled to an upper panel according to the present invention.

Referring to FIG. 22, the upper panel 21 couples to the top of the open front surface of the cabinet 2, and the upper frame 51 couples to the front surface of the upper panel 21. The control panel 7 couples to the bottom of the upper panel 21.

Specifically, the control panel fastening tab 513 extending from the rear surface at the top of the upper frame 51 is pressed against the rear surface of the upper frame fastening tab 214a formed on the upper panel 21. The fastening boss 73 of the control panel 7 is pressed against the front surface of the upper frame fastening tab 214a. A screw or similar fastening member is inserted from the rear through to the front of the control panel fastening tab 513.

Accordingly, one fastening member integrally couples the upper panel 21, upper frame 51, and control panel 7, so that assembly is ameliorated and fewer assembly components are used.

Below, the order in which the front portion of the laundry dryer 1 according to the present invention is assembled will be described step by step.

First Step

First, the outer cover 41 is coupled to the front surface of the cabinet cover 42.

In detail, the upper rib 416 formed on the upper portion of the outer cover 41 is inserted in the upper rib insert hole 426 formed in the upper surface of the cabinet cover 42. In this case, in order to easily insert the upper rib 416 into the upper rib insert hole 426, the process described in FIG. 18 is performed.

The outer cover 41 presses with a predetermined force while against the cabinet cover 42. In this way, the center hook 417 protruding from the rear surface of the outer cover 41 inserts in the center hook insert hole 431 of the cabinet cover 42, and the lower rib 418 protruding from the rear surface at the bottom of the outer cover 41 inserts into the lower rib insert hole 430 formed on the front surface at the bottom of the cabinet cover 42. At the same time, the ends of the plurality of fastening bosses 415 protruding from the rear surface of the outer cover 41 press against the recesses 422 recessed in the front surface of the cabinet cover 42. In this state, a screw or similar fastening member is inserted from the rear of the recesses 422 and screwed into the fastening bosses.

Second Step

In the second step, the side frames 52 are coupled to the sides of the front panel 4.

In detail, the side frame fastening tab 414 formed on the side surface of the outer cover 41 is inserted into the insert recess 528 of the side frame 520. Simultaneously, the frame rib 526 of the side frame 52 is inserted into the frame rib insert hole 413 of the outer frame 41. The frame hook 525 of the side frame 52 is inserted into the frame hook insert hole 423 of the cabinet cover 42.

Third Step

In the third step, with the side frame 52 fastened to the side surface of the front panel 4, the lower frame 53 is coupled to the bottom thereof.

In detail, the respective lower surfaces of the outer and cabinet covers 41 and 42 are pressed against the outer cover mount 532 and the cabinet cover mount 531 formed on the upper portion surface of the lower frame 53. Here, the standing rib 527 extending from the bottom of the side frame 52 is precisely fitted into the standing rib insert slot 534 of the lower frame 53. In this state, a fastening member is inserted into the bolting hole 533 formed in the cabinet cover mount 531, and inserts from the bottom to the top of the lower frame 53. The fastening member is inserted through the bolting hole 427 formed in the bottom of the cabinet cover 42.

Fourth Step

In the fourth step, the front panel 4 assembled in the third step, is installed on the front surface of the cabinet 2.

In detail, the process described in FIG. 17 for coupling the lower portion of the cabinet cover 42 to the lower panel 22 is implemented. The rear surface at the upper portion of the cabinet cover 42 is pressed against the front surface of the upper panel 21. Here, the upper surface of the cabinet cover 42 is pressed against the front surface of the upper panel 21, and then a fastening bolt is used to couple the cabinet cover 42 to the upper panel 21.

Fifth Step

In the fifth step, the upper frame 51 is coupled with the cabinet cover 42, the upper panel 21, and the side frame 52.

In detail, the fixing rib 515 formed at the lower portion of the upper frame 51 is inserted into the fixing rib insert hole 524 formed in the upper surface of the side frame 52. Here, the first and second ribs 516 and 517 protruding from the rear surface of the upper frame 51 insert into the first and second rib insert holes 215 and 216 of the upper panel 21. Then, the fastening hole 512 formed in the cabinet cover fastening tab 511 of the upper frame 51 and the upper frame fastening hole 424b of the cabinet cover 42 are aligned. A fastening member is then inserted through the fastening hole 512, the upper frame fastening hole 424b, and the upper frame fastening hole 218 formed in the upper panel 21.

Here, in the process of fastening the upper frame 51, the control panel fastening tab 513 protruding from the upper frame 51 is positioned behind the upper frame fastening tab 214a.

Sixth Step

In the final step, the control panel 7 is installed to the inside of the upper frame 51.

In detail, the outer cover fixing rib 75 formed at the bottom of the control panel 7 is inserted into the rib insert hole 412 formed in the upper surface of the outer cover 41. When the control panel 7 is pressed, the panel hook 76 inserts into the hook insert hole 213a of the upper panel 21. Subsequently, the upper frame fastening boss 73 protruding from the rear surface of the control panel 7 is positioned at the front surface of the upper frame fastening tab 214a. A fastening member is used to integrally couple the control panel fastening tab 513, the upper frame fastening tab 214a, and the upper frame fastening boss 73.

Here, each component of the fringe frame 5, the outer cover 41, and the cabinet cover 42 are coupled to form the front unit 10. However, the process of forming the front unit 10 and the coupling process of the assembled front unit 10 to the cabinet 2 are not limited to the above-described procedures, and the assembly steps may be changed in order.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A laundry dryer comprising:
a cabinet opened at a side thereof;
a drying drum disposed within the cabinet, for inserting articles to be dried;
a heating unit and a blower fan for supplying hot air into the drying drum;
a cabinet cover installed on the cabinet;
an outer cover detachably coupled to a front of the cabinet cover, painted with a predetermined color on at least a front surface thereof, and injection molded from a heat resistant plastic; and
a fringe frame enclosing a front edge portion of the cabinet.

2. The laundry dryer according to claim 1, wherein the outer cover is formed of an injection molded plastic capable of withstanding a temperature of at least 60° C.

3. The laundry dryer according to claim 1, wherein the outer cover includes a front surface that is smoothly finished using a superfinish treated mold.

4. The laundry dryer according to claim 1, wherein the outer cover is spray-painted with a paint of a predetermined color on at least the front surface thereof.

5. The laundry dryer according to claim 1, wherein the outer cover is dried at a temperature range of approximately 60-70° C.

6. The laundry dryer according to claim 1, wherein the outer cover is dried for approximately 40 minutes.

7. The laundry dryer according to claim 1, wherein the fringe frame includes:
a lower frame coupled to a bottom of at least one of the cabinet cover and the outer cover,
a side frame coupled vertically to both ends of the lower frame, and
an upper frame coupled to both upper ends of the side frame.

8. The laundry dryer according to claim 7, further comprising a control panel mounted to a top of at least one of the cabinet cover and the outer cover, and enclosed by the upper frame around an edge portion thereof.

9. The laundry dryer according to claim 7, wherein the side frame is coupled to a side of the cabinet cover or the outer cover.

10. The laundry dryer according to claim 1, wherein the fringe frame includes integrally-formed sides that do not separate from each other.

11. A laundry dryer comprising:
a cabinet;
a drying drum disposed within the cabinet;
a heating unit and a blower fan for supplying hot air into the drying drum;
a front panel including a cabinet cover installed at a front of the cabinet, and an outer cover made of a material different from the cabinet cover and painted with a colored paint on a front surface thereof, the outer cover coupled at a front of the cabinet cover;
a control panel mounted on a top of the front panel; and
a fringe panel installed on edges of the front panel and the control panel.

12. The laundry dryer according to claim 11, wherein the paint includes an acrylic base resin.

13. The laundry dryer according to claim 11, wherein the paint includes an aluminum powder for providing luster.

14. The laundry dryer according to claim 11, wherein the paint includes isopropylene alcohol for lowering a viscosity thereof when spraying the paint.

15. The laundry dryer according to claim 11, wherein the outer cover is painted by spraying the paint.

16. The laundry dryer according to claim 11, wherein the fringe frame includes a first frame covering a lower portion and both sides of the front panel, and a second frame mounted on a top portion of the first frame and enclosing the control panel.

17. The laundry dryer according to claim 11, wherein the cabinet cover is a metal plate with a predetermined strength.

18. The laundry dryer according to claim 11, wherein the laundry dryer is manufactured by:
forming the front panel by coupling the outer cover to the front of the cabinet cover,
coupling the fringe frame to the edge of the front panel, and
coupling the control panel to the top of the front panel.

19. The laundry dryer according to claim 11, wherein the outer cover is formed of a paintable ABS material that does not corrode when painted.

20. The laundry dryer according to claim 11, wherein the outer cover is formed of a GP35 material.

21. A laundry dryer comprising:
a cabinet opened on one side thereof;
a panel unit coupled to at least one of a top and a bottom of the opened side of the cabinet;
a cabinet cover made of a metal material, coupled to at least one of a top portion and a bottom portion of the panel unit, and forming a hole within for inserting and extracting laundry;
an outer cover formed of a non-metal material, pressed against a front surface of the cabinet cover, and forming a hole within for inserting and extracting laundry; and
a fringe panel forming a front peripheral portion of the cabinet.
